(19) United States
(12) Patent Application Publication
(10) Pub. No.: US 2008/0319860 A1
(43) Pub. Date: Dec. 25, 2008

(54) METHOD AND SYSTEM FOR ON-LINE BIDDING

(75) Inventor: Ishay HINKIS, Tel Aviv (IL)

Correspondence Address: MYERS WOLIN, LLC, 100 HEADQUARTERS PLAZA, North Tower, 6th Floor, MORRISTOWN, NJ, 07960-6834, US

(73) Assignee: ASIMONIX, LTD., Tel Aviv (IL)

(21) Appl. No.: 12/145,072

(22) Filed: Jun. 24, 2008

Related U.S. Application Data
(60) Provisional application No. 60/929,388, filed on Jun. 25, 2007.

(51) Int. Cl. G06Q 30/00

(52) U.S. Cl. 705/14

(57) ABSTRACT

A bidding application embedded into an online video sharing platform enables bidding for advertisements as an overlay on published video clips. The invention is applicable to any user generated video web site. Players, or bidding actors, may bid for the sponsorship of the video clip in an online bidding game.

### CROSS-REFERENCE TO RELATED APPLICATIONS

This application claims the benefit of U.S. Provisional Application No. 60/929,388 filed on Jun. 25, 2007, the contents of which are herein incorporated by reference.

### TECHNICAL FIELD

The present invention generally relates to a method of online bidding, and specifically to a bidding application embedded into an online video sharing platform.

### BACKGROUND OF THE INVENTION

Selling property by using auctions is well-known and has been used to attract sellers and buyers in a single arena for the purpose of selling and buying properties. Even today, and certainly in the early days, such auctions were handled manually with bidders assembling at a location, presenting their bids and assuming control of a property if their bid wins. With the advance of technology bidders could place their bids by phone, telegram, telex, and other forms of more advanced communication, that did not necessitate a person's presence in the location of the bid. An ultimate manifestation of such an auction theater which is fully electronic is the NASDAQ® stock exchange that is held automatically on computers.

With the advancement of recent years in the use of electronic commerce in general and the world-wide web (WWW) in particular, access to electronic transactions to a huge number of people was made possible. Access to the Internet is ubiquitous and is attractive to both sellers and buyers. The challenge of the use of modern time Internet commerce is reaching users with effective advertisements at locations that they actually reach and spend time on. The next challenge is to attempt to put a value on the advertisement slot such that an advertiser is willing to pay for it.

It is well known that many people on the Internet watch video clips. A popular site for this purpose is YouTube®, but others exist too. When a video clip is presented some of the video clips become a hit and are viewed by many users. Such video clips would have a significant more value to an advertiser than those which have low viewership. Establishing the value of such a video clip may be difficult initially as it is not easily monitored for monetization by putting specific monetary values on the video clip.

It would therefore be advantageous to provide a solution that would allow an owner of a video clip to place it for bidding and enjoy revenue thereof. It would be further advantageous if as a result of such continued bidding it would be possible to establish the value of such a video clip to an advertiser.

### SUMMARY OF THE INVENTION

Certain embodiments of the invention include a method for bidding for an hourly traded sponsorship banner (HTSB) of a video clip. The method comprises causing display of a notification that an HTSB of the video clip is up for a bid; during a predefined bidding period, receiving bids from bidders; upon expiration of the bidding period: determining a winner of the HTSB according to a predefined criteria; calculating a refund fee to be paid by the winner to a previous sponsor of the HTSB; and causing display of winner information with respect of the video clip at a time corresponding to the HTSB.

Certain embodiments of the invention also include a computer-readable medium having stored thereon computer executable code for bidding for an hourly traded sponsorship banner (HTSB) of a video clip. The computer executable code causes a computer to execute the process of causing display of a notification that an HTSB of the video clip is up for a bid; during a predefined bidding period, receiving bids from bidders; upon expiration of the bidding period: determining a winner of the HTSB according to a predefined criteria ; calculating a refund fee to be paid by the winner to a previous sponsor of the HTSB; and causing display of winner information with respect of the video clip at a time corresponding to the HTSB.

Certain embodiments of the invention include a system for bidding for an hourly traded sponsorship banner (HTSB) of a video clip. The system comprises a storage for storing at least a table containing bids on each HTSB of the video clip; a timer for measuring a time interval of a predefined bidding period and signaling when the bidding period ends; a memory unit for receiving bids from bidders and temporary storing the bids during the bidding period; and a processor for processing bids stored in the memory and determining a winner of the HTSB, wherein the processor is further capable of calculating a refund fee to be paid by the winner to a previous sponsor of the HTSB, and causing display of winner information with respect of the video clip at a time corresponding to the HTSB.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a flowchart illustration of a method of online bidding implemented in accordance with an embodiment of the present invention;

FIG. 2 is a schematic diagram illustrating the online bidding from the sponsor's perspective;

FIG. 3 is a schematic illustration of the roles performed by each of the ‘actors’ associated with the online bidding;

FIG. 4 is a tabular illustration of the real-time history of the status of the sponsorship bidding;

FIG. 5 is an illustration of a video clip for which bidding is active; and

FIG. 6 is a video clip illustrating the addition of a sponsor's logo.

### DETAILED DESCRIPTION OF THE INVENTION

It is important to note that the embodiments disclosed by the invention are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

In accordance with certain embodiments of the invention a bidding method and system embedded into an online video sharing platform are provided. The method enables the bidding for advertisements as an overlay on published video clips. The principles of the invention are applicable to any user generated video web site. Players, or bidding actors, may bid for the sponsorship of the video clip in an online bidding game.

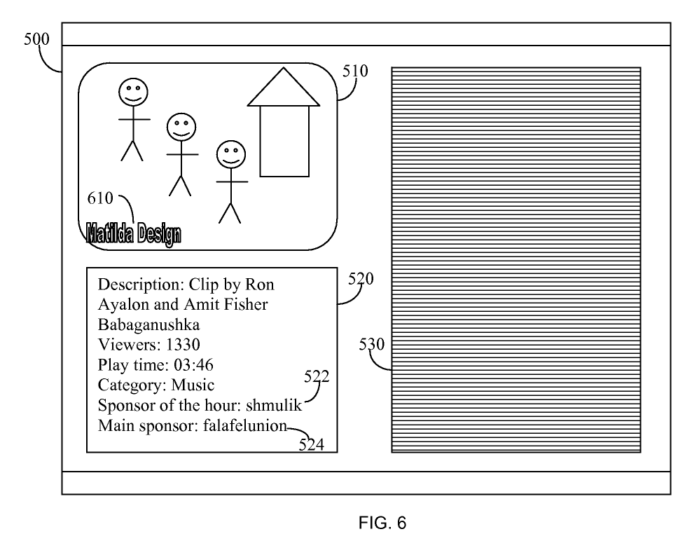

The following terms are used for the purpose of the invention and shall have their respective identified meaning for the sake of explanation and not necessarily limitation. “Active Bid” means that at least one bid has been placed. “Closed Bid” means that a bidding countdown is over. “HTSB” is an acronym for an hourly traded sponsorship banner. The HTSB appears on a clip for a full hour every day throughout the whole week. HTSB can appear in varied ways according to the choice of the host site, for example: 1) as part of the clip's information next to name of clip, creator of clip; 2) as a banner on the clip and; as a watermark on the clip. These examples are further illustrated in FIGS. 5 and 6. “HTSB Chart” refers to a part of the clip's information the HTSB value chart will be one of the view options in which information regarding sponsorship value and bidding values are summed.“HTSB Content” means an owner's choice and can be a name' logo, internet link, etc. The HTSB content is reloaded every hour featuring the present HTSB owner. “HTSB Value” refers to the amount of the winning bid for the sponsorship. “Open for Bid” means that the clip is available for bidding but not necessarily active. “Refund” refers to the amounts due to a previous owner by the new HTSB owner such that if A is the previous HTSB value, B is the new HTSB value, C is the daily HTSB rent, D the number of days the previous owner owned the banner, then Z is the refund amount which is: Z=B−A−C*D. It should be noted that daily HTSB rent is an optional parameter that is used to prevent a situation of a bidder holding a slot for a long period of time without any benefit for the system (no transactions). If C is set to ‘0’ then there is no effect on Z. In one embodiment of the invention the refund Z is shared between the owner of the HTSB and the owner of the video clip. In another embodiment the system operator also enjoys a portion of the refund.

In an exemplary and non-limiting embodiment of the invention, each HTSB slot represents one hour of the day, for example, 13:00-14:00, which is a HTSB slot offered for bidding. Every owner, i.e., a successful bidder, of an HTSB slot obtains the rights to have his name/logo/internet link mentioned in a dominant place on the video clip page.

All 24 hourly sponsorship slots are rated in a bid chart by their sponsorship value. The sponsor who holds the highest HTSB value automatically becomes the main sponsor of the clip. The main sponsor may obtain additional rights such as having his name/logo/internet link displayed in a dominant place in the clip page in addition to a watermark on the clip itself for as long as he keeps the main sponsor status. When a sponsor loses his sponsorship status in a bid, he may obtain a refund based on a formula related to the increase in value of the slot.

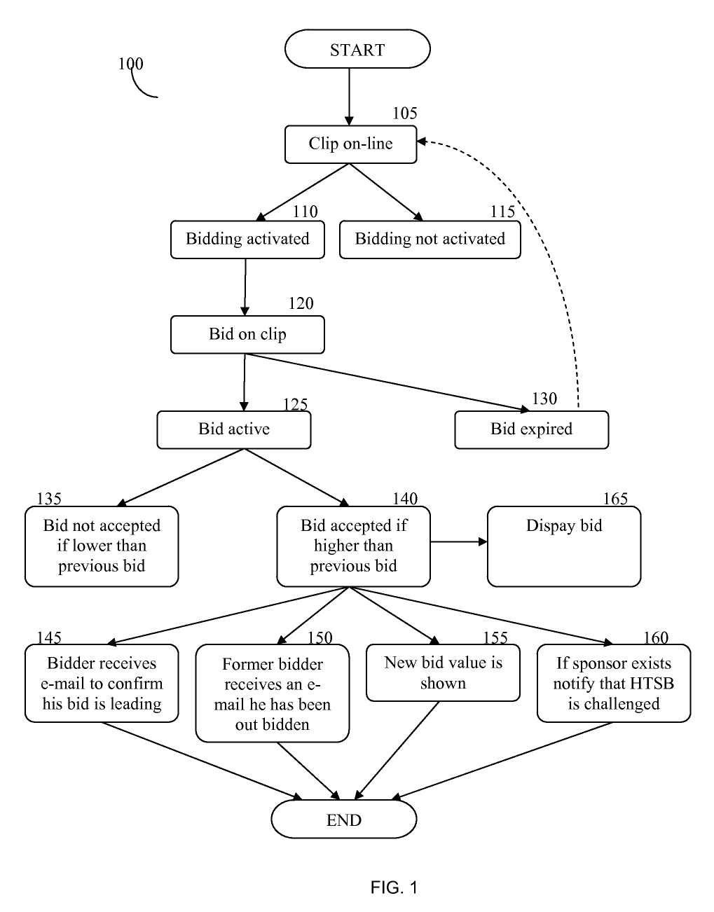

The invention creates a financial method that rewards media creators for the success of their video clip. Income may be generated from the online bidding that challenges players' ability to forecast the success of media creation. Players may be rewarded by the increase in value of a HTSB slot for which they have bided. The invention enables sponsors to link their commercial sponsorship to the success of a video clip. The principles of the invention are described with reference to FIGS. 1-4.

FIG. 1 is a non-limiting and exemplary flowchart 100 illustrating the method of online bidding implemented in accordance with an embodiment of the present invention. Once a clip is online 105, bidding may be activated 110. As long as bidding is active 125, each time a higher bid is submitted 120, the amount is displayed 165 and a notification is made to both the previous bidder 150 and the new highest bidder 145. Bids that are lower than the previous bid are not accepted 135. If a bid period has expired 130, the no bid is accepted for the respective HTSB.

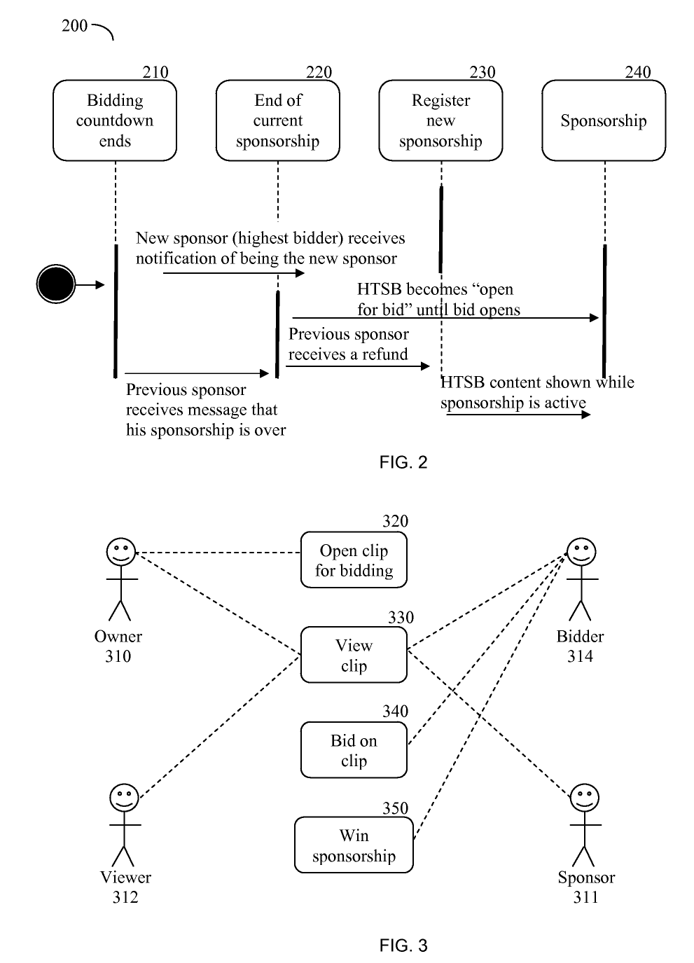

FIG. 2 shows a schematic diagram 200 illustrating the online bidding from the sponsor's perspective. Accordingly, when a bidding countdown ends 210, the new sponsor receives notification of being a new sponsor. Also, the previous sponsor receives a message indicating that the sponsorship is now over. At a subsequent time the previous sponsorship expires 220 and as a result the old sponsor receives a refund as explained above. The HTSB receives the state “open for bid” until the bid is opened. The new sponsorship is now registered 230, and the respective HTSB content is shown while the sponsorship 240 period has not expired.

FIG. 3 is a schematic illustration of the roles performed by each of the ‘actors’ associated with the online bidding method. Actors may include an owner 310 of the clip, a successful main sponsor 311 of the clip, a non-active viewer 312 and a bidder 311. The activities that they may be involved in included, but are not limited to, opening a clip for bidding 320, viewing a clip 330, bidding on a clip 340, and winning a sponsorship 350. The owner 310 may open a clip for bidding 320 and may view the clip 330. However, such an owner cannot bid on or gain sponsorship of his own video clip unless the system allows otherwise. A non-active viewer 312 only views video clips 330 and is otherwise uninvolved in the process. A sponsor 311 is a previous bidder who has won an HTSB and hence is out from the bidding cycle and is the current sponsor of the video clip with capabilities of viewing the clip 330. The bidder 314 can view the clip 330, bid on a clip 340, and once the bidding period is over may become the winner of the sponsorship 350 for the video clip. It would be appreciated that by using this system the value of the video clip at each HTSB is continuously upgraded benefitting both the original owner of the video clip as well as the sponsors thereto. Every actor can assume any of the functions described in FIG. 3.

The invention disclosed herein comprises various components of an online bidding method. The components include:
Clip Bidding
Actors
Owner
Viewer
Bidder
Sponsor
Use Cases
Bidding
Win Sponsorship

Clip bidding enables a financial method that rewards media creators for success in achieving significant viewership and/or significant viewership within a targeted/specific community. While bidders are bidding for sponsorship, the system enables the determination of the value of the video clip and access to those who are willing to bid higher numbers to gain sponsorship status over lengthy period of times in desired HTSBs. From the bidders' perspective it is a game of challenge of forecasting the success of a media creation and benefiting from correct predictions. From a potential advertiser's point-of-view there is a determination of the popularity and therefore the value of a video clip.

Specifically, an owner of a video clip may make a video available on a web site and be able to promote the video clip by enabling the bidding for sponsorship of the video clip. The owner is rewarded by the HTSB system in accordance with the success of the video clip put up for bid. A viewer will of course be exposed to the sponsorship of the video clip in addition to being exposed to the video clip itself. The viewership may be also recorded thereby contributing to the overall number of viewers watching the video clip. A bidder may be any logged visitor that has placed a bid on a video clip. The bidder places a bid in accordance with the principles of the disclosed invention and if the bidder places the highest bid by the closing time of the bidding period, the bidder wins the bid. By becoming a sponsor of a video clip the sponsor will share certain return when a higher bidder places a bid at a subsequent bidding period. The sponsor is therefore a winning bidder.

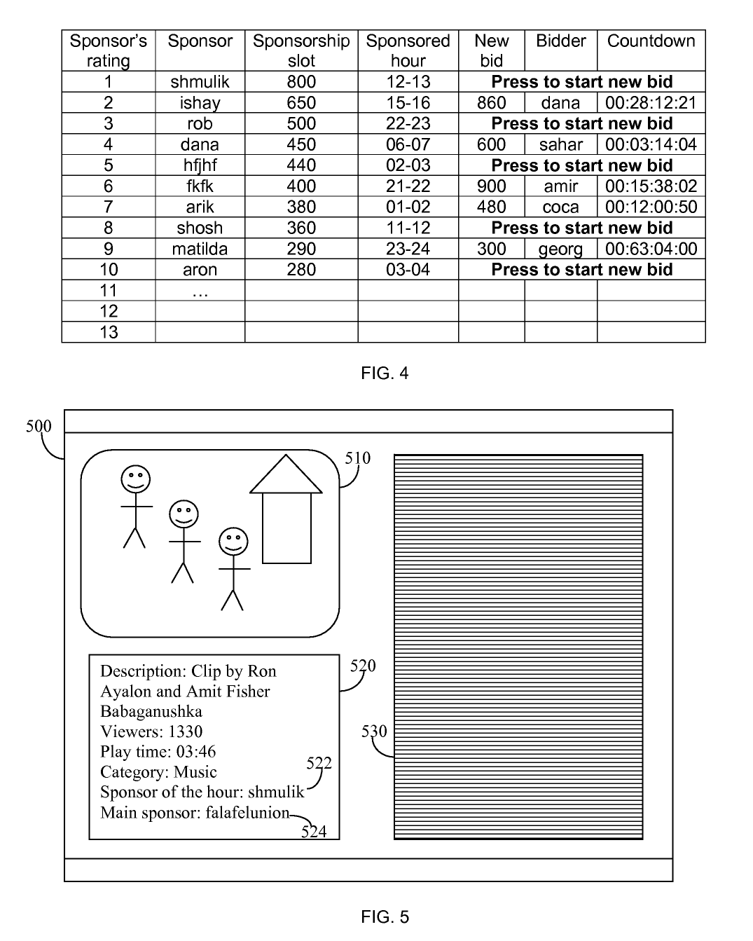

In accordance with the principles of the invention a bidder can purchase as many HTSBs of the video clip that may be available. In certain embodiments of the invention a plurality of types of sponsors may be identified. For example, a “main sponsor” may get to appear as a watermark on the video clip for as long as the main sponsor retains that status. A “sponsor of the hour” may have the sponsor information presented during the sponsorship hour and visible in the video display box. The “leading sponsors”, for example, the five highest sponsors, may be listed in a sponsor chart immediately available in the video clip view page. The details of a “regular sponsor” are shown only in the sponsors' table which is visible only separately from the video clip being displayed unless the system is enabled to allow otherwise. An exemplary and non-limiting such sponsor table is described with reference to FIG. 4.

In accordance with the principles of the invention a clip may be open for bidding if the video clip is on-line and has not been moderated negatively. Furthermore, the clip ought not to be already open for bidding for the same HTSB. In one embodiment opening a bid for a video clip occurs only if a minimum amount of clip views has occurred. This minimum number can be determined by the system. Once open for bidding there is a period of time when bids are accepted for the specific HTSB. In order to perform this action the owner (e.g., owner 310) selects a clip he owns, for example a clip in “My Clips” of that owner. The owner then selects the “make clip available for bidding” option and thereafter the system opens the clip for bidding. When a viewer (e.g., a viewer 312) views the video clip then, if the video clip is open for bidding the system shows, in addition to the display of the video clip, bidding information respective of the video clip.

The bidding process, in accordance with the principles of the invention, begins once an HTSB is open for bidding. A viewer must be logged on to become a bidder into the system, transferring them from a non-active viewer into a bidder (e.g., a bidder 314). The bidder sets a price that must be higher than the HTSB value, or the highest bid made at that point in time. A new bid is shown as active as well as the time to end bidding for the specific HTSB. The length in time for bidding may be set, in one embodiment by the system or the web site, and be for example, seven days long. Other settings are of course possible without limiting the scope of the invention. The system is enabled to send a message to a bidder when he provides a leading bid to an HTSB. The former bidder receives a message that he has been out bidden. The new bid value is displayed with respect to the video clip and the table as discussed hereinabove. If a sponsor (e.g., sponsor 311) for the HTSB already exists, then such sponsor shall also receive a notification that his HTSB is being challenged, effectively providing a notification that the sponsor is in a position of losing the HTSB.

Once the bidding process is over the highest bid is confirmed and acknowledged. The information that the new sponsor wants to present, e.g., a name, a logo, an internet link, etc., is collected from the sponsor and will be displayed at the correct time when the HTSB is at the right time slot. It will then be displayed whenever the video clip is presented for the entire duration of time, for example, during a period of one hour. This shall be repeated at every respective time slot for the HTSB for the entire duration of the sponsorship, for example, a period of seven days. The HTSB value and the link to the bid are shown in a dominant spot. Once the new bidder becomes the sponsor, a financial transaction takes place where the old sponsor of the HTSB gets a refund calculated, for example, in the manner described above. It should be noted that this is merely an exemplary refund formula and other formulas may be used without departing from the scope of the disclosed invention. In one embodiment the owner also shares a portion of the refund.

FIG. 4 illustrates the status in real-time of sponsors, in tabular format 400, ordered according to the sponsor rating. The table 400 also shows the sponsorship slot bid, the sponsored hour and whether a new bid has been entered, together with the name of the new bidder, the amount of the bid and the time left to enter a bid for that HTSB slot.

FIG. 5 illustrates the principles of the invention where a video clip 510 is placed in a web page 500, for which bidding is active, alongside pertinent information 520 relating to the clip including the number of views. The name/logo/internet link of the hourly sponsor 522 and the main sponsor 524 are also prominently displayed. Area 530 exemplifies other areas used by the web site.

FIG. 6 is a video clip 510 in a web page 500 with the addition of a sponsor's logo 610, placed in accordance with the principles of the invention.

The foregoing detailed description has set forth a few of the many forms that the invention can take. It is intended that the foregoing detailed description be understood as an illustration of selected forms that the invention can take and not as a limitation to the definition of the invention. It is only the claims, including all equivalents that are intended to define the scope of this invention.

Most preferably, the principles of the invention are implemented as a combination of hardware, firmware and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPU”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

What we claim is:

1. A method for bidding for an hourly traded sponsorship banner (HTSB) of a video clip, comprising:
causing display of a notification that an HTSB of the video clip is up for a bid;
during a predefined bidding period, receiving bids from bidders;
upon expiration of the bidding period:
determining a winner of the HTSB according to a predefined criteria;
calculating a refund fee to be paid by the winner to a previous sponsor of the HTSB; and
causing display of winner information with respect of the video clip at a time corresponding to the HTSB.

2. The method of claim 1, wherein the winner information is determined by the winner and selected from a group of: overlay over the video clip, watermarking the video clip, and placement of advertisement content on a web page within a video clip in which the video clip is displayed.

3. The method of claim 1, wherein calculating the refund fee further comprising:
computing a first value by subtracting from the bid a value equal to a bid of the previous sponsor that enabled the previous owner to be a winner of the HTSB; and
subtracting the first value from a value computed by multiplying an HTSC daily rent value by a number of days sponsorship was owned by the previous sponsor.

4. The method of claim 3, wherein the refund fee is shared between at least one of: an owner of the video clip, a previous owner of the HTSB, and a system operator.

5. The method of claim 1, further comprising:
sending a message to the winner reporting success of the bid;
sending a message to the previous sponsor; and
crediting the previous sponsor with the refund fee.

6. The method of claim 1, further comprising:
causing display of a table containing bids on each HTSB of the video clip, wherein the winner is a bidder with the highest bid on each HTSB.

7. The method of claim 6, wherein a highest bid from the table containing bids is designated a main sponsor.

8. The method of claim 7, further comprising:
causing display of the main sponsor information in addition to the winner information.

9. A computer-readable medium having stored thereon computer executable code for performing bidding for an hourly traded sponsorship banner (HTSB) of a video clip, comprising:
causing display of a notification that an HTSB of the video clip is up for a bid;
during a predefined bidding period, receiving bids from bidders;
upon expiration of the bidding period:
determining a winner of the HTSB according to a predefined criteria;
calculating a refund fee to be paid by the winner to a previous sponsor of the HTSB; and
causing display of winner information with respect of the video clip at a time corresponding to the HTSB.

10. The computer-readable medium of claim 9, wherein the winner information is determined by the winner and selected from a group of: overlay over the video clip, watermarking the video clip, and placement of advertisement content on a web page within a video clip in which the video clip is displayed.

11. The computer-readable medium of claim 9, wherein calculating the refund fee further comprising:
computing a first value by subtracting from the bid a value equal to a bid of the previous sponsor that enabled the previous owner to be a winner of the HTSB; and
subtracting the first value from a value computed by multiplying an HTSC daily rent value by a number of days sponsorship was owned by the previous sponsor.

12. The computer-readable of claim 11, wherein the refund fee is shared between at least one of: an owner of the video clip, a previous owner of the HTSB, and a system operator.

13. The computer-readable medium of claim 9, further comprising:
sending a message to the winner reporting success of the bid;
sending a message to the previous sponsor; and
crediting the previous sponsor with the refund fee.

14. The computer-readable medium of claim 9, further comprising:
causing display of a table containing bids on each HTSB of the video clip, wherein the winner is a bidder with the highest bid on each HTSB.

15. The computer-readable medium of claim 14, further comprising:
causing display of a main sponsor information in addition to the winner information, wherein a highest bid from the table containing bids is designated the main sponsor.

16. A system for bidding for an hourly traded sponsorship banner (HTSB) of a video clip, comprising:
a storage for storing at least a table containing bids on each HTSB of the video clip;
a timer for measuring a time interval of a predefined bidding period and signaling when the bidding period ends;
a memory unit for receiving bids from bidders and temporary storing the bids during the bidding period; and
a processor for processing bids stored in the memory and determining a winner of the HTSB, wherein the processor is further capable of calculating a refund fee to be paid by the winner to a previous sponsor of the HTSB, and causing display of winner information with respect of the video clip at a time corresponding to the HTSB.

17. The system of claim 16, wherein time duration of the HTSB is configurable to enable implementation of one or more length the HTSB.

18. The system of claim 16, wherein the winner information is determined by the winner and selected from a group of: overlay over the video clip, watermarking the video clip, and placement of advertisement content on a web page within a video clip in which the video clip is displayed.

19. The system of claim 16, wherein the processor is further capable of alerting a current owner of a first HTSB of a bid that will cause the owner to lose ownership of said the HTSB.
